(19) United States
(12) Patent Application Publication
(10) Pub. No.: US 2023/0200512 A1
(43) Pub. Date: Jun. 29, 2023

(54) SHAVING BLADE PICKING TOOL AND RELATED METHODS OF USE

(71) Applicant: Michel Yazdekhasti, Edmonton (CA)

(72) Inventor: Michel Yazdekhasti, Edmonton (CA)

(21) Appl. No.: 17/561,919

(22) Filed: Dec. 24, 2021

(51) Int. Cl. A45D 27/46; B26B 21/40; B08B 1/00

(52) U.S. Cl. CPC A45D 27/46; B26B 21/40; B08B 1/005

(57) ABSTRACT

A shaving blade picking tool has a finger grip part having opposed finger-tip-contacting faces separated by a peripheral side edge; and a pick part extended from a leading end of the finger handle part, the pick part having opposed faces separated by a peripheral pick part side edge, which is sized to fit between adjacent blades of a multi-blade hair razor in use. A method involves inserting a pick part of a shaving blade picking tool between adjacent blades of a multi-blade hair razor to dislodge debris between the adjacent blades, in which the pick part is extended from a leading end of a finger grip part, which is operated by a user whose finger tips grip opposed finger-tip-contacting faces of the finger grip part.

### TECHNICAL FIELD

This document relates to shaving blade picking tools and related methods of use.

### BACKGROUND

The following paragraphs are not an admission that anything discussed in them is prior art or part of the knowledge of persons skilled in the art.

Multi-blade shaver heads often become clogged with debris, such as from trimmed hair, skin, oil, and dirt. Blade cleaning may be attempted using a cloth or by running a stream of water through the shaver head, but such methods are often ineffective at removing the debris, and may result in blade wear, deformation, or dulling.

### SUMMARY

A shaving blade picking tool is disclosed comprising: a finger grip part having opposed finger-tip-contacting faces separated by a peripheral side edge; and a pick part extended from a leading end of the finger handle part, the pick part having opposed faces separated by a peripheral pick part side edge, which is sized to fit between adjacent blades of a multi-blade hair razor in use.

A method is also disclosed comprising inserting a pick part of a shaving blade picking tool between adjacent blades of a multi-blade hair razor to dislodge debris between the adjacent blades, in which the pick part is extended from a leading end of a finger grip part, which is operated by a user whose finger tips grip opposed finger-tip-contacting faces of the finger grip part.

In various embodiments, there may be included any one or more of the following features: The pick part defines prongs at a leading end of the pick part. The prongs are defined by opposed corners at the leading end of the pick part. The pick part is rectangular in shape with: a straight leading edge, which defines the leading end of the pick part and the opposed corners; and straight side edges, which extend from the finger grip part to the leading end of the pick part. The finger grip part has an oblong, bulbous planar shape with the peripheral side edge being curved. The pick part is integrally connected to the finger grip part. The finger grip part and pick part form a sheet. The finger grip part and pick part are formed by sheet metal punching. The shaving blade picking tool comprises metal. The metal comprises stainless steel. All edges, corners, and faces of the shaving blade picking tool are polished. All edges and corners of the shaving blade picking tool are beveled or rounded. A thickness of the pick part defined between the opposed faces of the pick part is between 0.01 and 0.5 millimeters. The thickness of the pick part is between 0.2 and 0.3 millimeters. A lateral width of the pick part between opposed sides of the peripheral pick part side edge is between 2 and 10 millimeters. The lateral width is between 5 and 8 millimeters. A length of the pick part between leading and trailing ends of the pick part is between 2 and 6 millimeters. A combination comprising the shaving blade picking tool with the pick part inserted between adjacent blades of a multi-blade hair razor. The pick part is inserted between the adjacent blades from one of: a front cutting face of a blade-mounting head of the multi-blade hair razor; or a rear face of a blade-mounting head of the multi-blade hair razor.

The foregoing summary is not intended to summarize each potential embodiment or every aspect of the subject matter of the present disclosure. These and other aspects of the device and method are set out in the claims.

### BRIEF DESCRIPTION OF THE FIGURES

Embodiments will now be described with reference to the figures, in which like reference characters denote like elements, by way of example, and in which:

FIG. 1 is a top plan view of a shaving blade picking tool.

FIG. 1A is a close-up view of the circular area denoted in dashed lines in FIG. 1.

FIG. 2 is a side elevation view of the shaving blade picking tool of FIG. 1.

FIG. 2A is a close-up view of the circular area denoted in dashed lines in FIG. 2.

FIG. 3 is a view of the underside of the shaving head of a multi-blade razor being cleaned by the shaving blade picking tool of FIG. 1.

FIGS. 4-7 are a sequence of section views taken along the 4-4 section lines of FIG. 3, illustrating methods of using the shaving blade picking tool of FIG. 1 in different ways to remove clumps of hair and debris stuck between blades of the multi-blade razor. FIGS. 4-5 illustrate a sequence where the shaving blade picking tool is inserted into a blade gap between adjacent blades from a rear side of the shaving head. FIGS. 4, 6, and 7 illustrate a sequence where the shaving blade picking tool is inserted into a blade gap between adjacent blades from a front side of the shaving head, with the tool changing angle as it presses one of the blades down to enter the gap.

FIG. 8 is a view of the top side of the shaving head of a multi-blade razor being cleaned by the shaving blade picking tool of FIG. 1.

### DETAILED DESCRIPTION

Immaterial modifications may be made to the embodiments described here without departing from what is covered by the claims.

Unwanted body hair may be removed via a variety of suitable methods, the most common of which include depilation and epilation. Depilation refers to the removal of the part of the hair above the surface of the skin, leaving the root intact under the skin. Common physical forms of depilation include cutting, which includes trimming, clipping, and shaving, for example via static methods such as with a traditional blade tool or scissors, or via motorized methods such as with an electric shaver. Chemical depilatories may be used to dissolve or weaken hair by breaking disulfide bonds that link protein chains of hair. Depilatories may take the form of creams or powders, and may be used alone or in combination with mechanical depilation methods. Depilation may also involve buffing away hair via a friction pad or other device that incorporates a rough sandpaper texture. Epilation, on the other hand, refers to the removal of the entire hair from the root, and may involve one or more of tweezing, waxing, sugaring, threading, or electrology.

A user may wish to trim or remove hair in certain regions, such as unwanted facial or body hair. Some of the most common regions that people shave, for example using an electric or non-electric razor, include the face, legs, armpits, chest, back, and groin, but any part of the body can be shaved, including the scalp in some cases. Some types of hair, such as facial hair, may need to be shaved regularly, for example daily, while other regions may not have to be shaved as often. Unwanted hair may be shaved to a sufficient extent, for example fully shaven to a clean cut, or trimmed and stylized, for example with beards, mustaches, and other variations. A razor may be used to remove such hair.

A non-electric razor may be used to shave hair on the face or body. Non-electric bladed shaves may be used for wet shaving, in which a gel or foam is pre-applied to the area to be shaved, in order to allow the razor to smoothly glide and cut the hair. The blades of a multi-blade razor are able to cut the hair through hysteresis, which is a process in which the leading blade lifts and cuts the hair, allowing trailing blades to access and cut the hair further before the hair recedes back into the follicle. A single-blade razor can only cut what is visible at the surface of the skin. A multi-blade razor can go further. The first blade starts the job, by cutting the hair and, in the process, gently lifting it from the skin. Before the hair has time to fully withdraw, the next blade comes along and cuts it further down. Each blade repeats the process. Once the multi-blade razor has passed, the skin and hair relax, and the hair retracts beneath the surface. As the hair is cut shorter, each blade is positioned fractionally closer to the skin than the preceding blades, creating a comfortable shave with a smooth finish.

Referring to FIG. 3, a non-electric multi-blade razor 48 may have a variety of parts. The razor 48 may have a shaving head 50 and a handle 66. The shaving head 50, which may be detachable from the handle 66 (for example to permit the head 50 to be disposed of after wear, while the handle 66 may be re-used). The head 50 may have plural blades 68. The blades 68 of the razor 48 may be flexible or resilient, allowing the blades 68 to conform to the contour of the user's face during use. The blades 68 may be attached to the sides 56 of the head 50 of the razor 48 at either end 72 of the blades. The blades 68 may be mounted to the electrology head 50 using a flexible or resilient mount 78, such as a rubber, silicone, or other elastomeric material, allowing the blades 68 to resiliently move, depress, and extend, to further conform to the shape of the surface being shaved. The razor head 50 may include one or more pads, such as a comfort pad 80 at a leading end 52 of the head 50, and a lotion pad 82 at a trailing end 54 of the head 50, to reduce discomfort that may otherwise be experienced during shaving. The handle 66 may be connected to the head 50 of the razor 48 via a suitable mechanism, such as a pivotal connection, which may allow the head 50 of the razor 48 to closely follow the contour of the user's face.

A common experience with a multi-blade razor is that a gap between adjacent blades may frequently become clogged with debris during shaving. Any of a number of types of debris, such as hair clippings from cut hair, loose or dry skin scraped off the user's face or body, dirt, oil, and others, may become lodged and compressed together, between adjacent blades 68 of the multi-blade razor 48. Such debris may thereafter restrict the razor 48 from effective shaving, for example by blocking entry of hair into the blade gap. A razor 48 with clogged blades may also cause irritation of the skin of the user with each stroke of the razor, as additional strokes may be required when the blades do not cut effectively. A razor 48 or head 50 that becomes clogged will often be disposed of prematurely as a result of a perceived permanent loss of function.

The ability to clean clogged hair clippings and debris out of a razor may be useful to extend the life of the razor. Clogging may cause the blades to become dull and/or rusty if clogging is not removed. Shaving companies recommend that the blades are only cleaned with warm water, to prevent dulling and deformation of the blades, which are extremely tiny and precisely manufactured, and sensitive to damage from contact with objects harder than hair or skin. It is suggested that the user either rinse the blades under warm running water, or fill the sink with warm water and shake the blades in the water while submerged.

Despite the above, there remain several methods that have been devised to attempt more efficient cleaning of such debris. In order to avoid damaging the blades, people have been known to knock the razor head against the walls of the sink or other hard surface in an attempt to dislodge the hair clippings and debris from between the razor blades. Other methods include rubbing the blades with a soft rag, a toothbrush, or a toothpick. The use of rags and toothbrushes is gentle enough to avoid dulling the blades, although may still cause unwanted deformation of the sensitive blades. An additional failing with rags, toothbrushes, and toothpicks is that even if such do not dull the blades, they are not able to get all the way in between the blades to sufficiently and effectively dislodge all the clogged debris therein. Thus, the aforementioned cleaning methods often result in an incomplete clean that does not completely solve the hair clogging problem, or that damages, and prematurely ends the life of, a particular shaving head or tool.

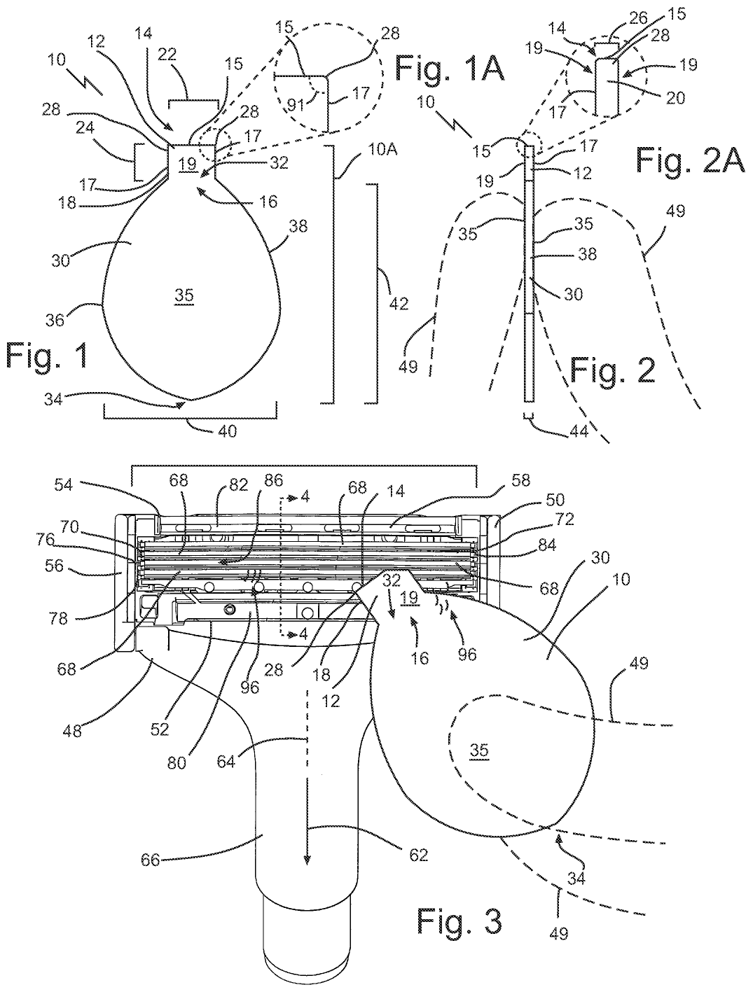

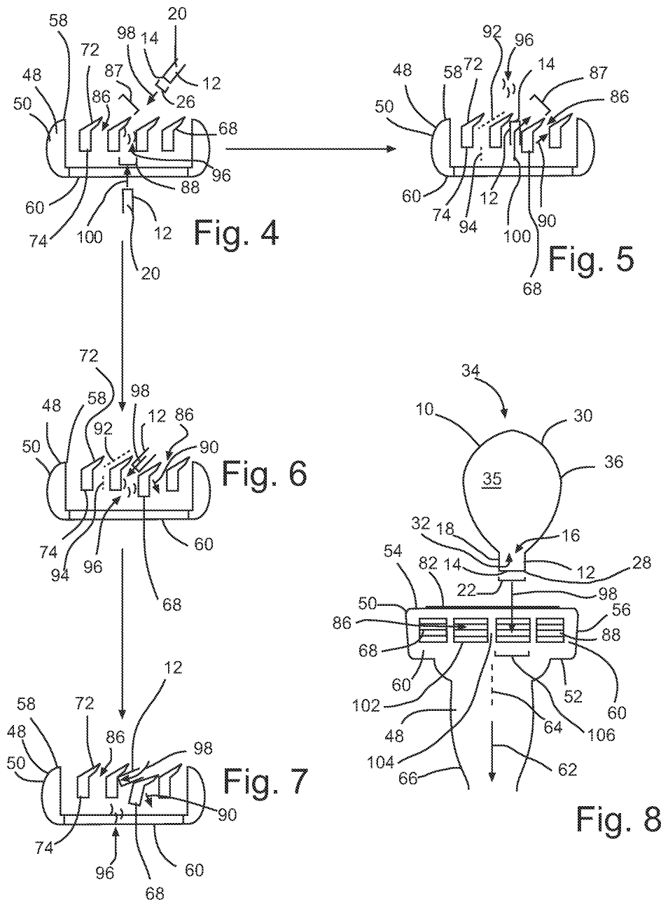

Referring to FIGS. 1 and 2, a shaving blade picking tool 10 may be provided to clean debris from between adjacent blades of a multi-bladed razor. The shaving blade picking tool 10 has a finger grip part 30 and a pick part 12. The finger grip part 30 may define opposed finger-tip-contacting faces 35. The finger grip part 30 may function as a handle for the tool 10. The finger-tip-contacting faces 35 may be separated by a peripheral side edge 38. The finger grip part 30 may define a leading end 32, a trailing end 34, and arcuate sides 36. The pick part 12 may extend from leading end 32 of the finger grip part 30. The pick part 12 may have opposed faces 19, which may be separated by a peripheral pick part side edge 20. The pick part 12 may define a leading end 14, a trailing end 16, side edges 17, and a leading edge 15. Referring to FIGS. 5 and 6, the pick part 12 may be sized to fit between adjacent blades 68 of a multi-blade razor 48 in use.

Referring to FIGS. 1-3, the pick part 12 may define one or more prongs, such as a pair of prongs, at the leading end 14 of the pick part 12. The pair of prongs may be of a suitable shape and size in order to fit between the adjacent blades 68 of a multi-blade razor 48. The pair of prongs may be defined by opposed corners 28 at the leading end 14 of the pick part 12. In other cases, the prongs may project out of the body of the pick part 12, for example in the shape of fork prongs or others. The provision of a pointed or pronged projection on the pick part 12 permits the prong, for example one or both corners 28, to be inserted within a blade gap 86 between adjacent blades 68, to provide additional precision in clearing debris. A prong may define an edge to edge angle 91 (defined within the pick body between the edges) of ninety degrees or less, although other angles may be used.

Referring to FIGS. 1-3, the pick part 12 may be shaped to allow effective cleaning of the blades 68 of the multi-blade razor 48. The pick part 12 may have a suitable shape, such as the shape of a rectangle. The pick part 12 may have a straight leading edge 15, which may define the leading end 14 of the pick part 12 and the opposed corners 28. The pick part 12 may have straight side edges 17, which may extend from the finger grip part 30 to the leading end 14 of the pick part 12. The rectangular shape of the pick part 12 may be defined by the straight leading edge 15 and the straight side edges 17, and may extend from a leading end 32 of the finger grip part 30 to the leading end 14 of the pick part 12. The pick part 12 may have plan shapes other than rectangular, such as triangular, trapezoidal, rounded, arcuate, polygonal, and others. However, a rectangular shape as shown may permit the lose pick part 12 to have a dual function, namely the ability to use the straight leading edge 15 as a piston to achieve rough clear out of a clogged gap by displacing the debris out of the gap via an axial movement, as well as to use the corners 28 for precise cleaning of relatively smaller or more difficult to remove clogs by scraping debris from the gap via a lateral movement relative to the blades.

Referring to FIGS. 1-3, the finger grip part 30 of the tool 10 may be suitably shaped to provide surfaces that may be easily gripped and manipulated, such as the finger-tip-contacting faces 30. The finger grip part 30 may have an oblong bulbous shape with the peripheral side edge 38 being curved. The part 30 may have a shape of the outline silhouette of a pear. The oblong bulbous shape may be formed by arcuate sides 36 of the finger-tip-contacting faces 30. The leading end 32 of the oblong bulbous shape may depend from the trailing end 16 of the pick part 12 at one end, and may form the trailing end 34 of the finger grip part 30 at the other end. The dimensions of the finger grip part 30 may be selected to facilitate use by a user with finger tips 49 of an average adult male or female fingertip size. A lateral width 40 between sides 36 may be sized to within a suitable width range, such as between 1.5 and 2.5 millimeters in maximum width, for example between 2.5 and 2.9 millimeters in length. A length 42 between ends 32 and 34 may be sized to within a suitable length range, such as between 2 and 3.5, for example between 3 and 3.5, millimeters in maximum length. A thickness 44 of the finger grip part 30 defined between the opposed faces 35 of the pick part may be between 0.01 and 0.5 millimeters, for example between 0.2 and 0.3 millimeters.

Referring to FIGS. 1-3, the shaving blade picking tool 10 may have a suitable construction. The pick part 12 may be integrally connected to the finger grip part 30. The trailing end 16 and the sides 18 of the pick part 12 may seamlessly transition into the leading end 32 and the arcuate sides 36 of the finger grip part 30, respectively. The pick part 12 and the finger grip part 30 may form a sheet. A sheet is understood to include a relatively thin, planar object with flat faces and a thin peripheral edge. The sheet may be resilient or rigid in construction. Referring to FIGS. 1, 1A, 2, and 2A, the shaving blade picking tool 10 may comprise a suitable metal, such as aluminum sheet metal or stainless steel. Sheet metal may be used.

Referring to FIGS. 1-3, the finger grip part 30 and the pick part 12 may be formed by a suitable process, such as sheet metal punching. Sheet metal punching includes a cutting process in which material is removed from a piece of sheet metal by applying a great enough shearing force. A die is located adjacent, for example underneath, the sheet metal, and has a cutout of the desired shape. Punches and dies of standard shapes may be used, but custom tooling may be made for punching complex shapes. The punch press may drive the punch downward at high speed through the sheet and into the die below. There may be a small clearance between the edge of the punch and the die, causing the material to quickly bend and fracture. The desired shape that is punched out of the sheet may then fall through the tapered opening in the die. This process can be performed on a manual punch press, but computer numerical controlled punch presses are most common. A CNC punch press can be hydraulically, pneumatically, or electrically powered and deliver around 600 punches per minute. Other suitable methods may be used to cut the tool 10 from sheet metal, including routing or laser cutting. In some cases, molding may be used.

Referring to FIGS. 1, 1A, 2, and 2A, the surfaces of the tool 10 may be structured to avoid cutting the user's skin and dulling the blades 68. The punching or routing/cutting of sheet metal may result in sharp edges and burrs in the area that was cut. To eliminate these burrs and sharp edges, post-forming deburring processes may be used. For example, wet and dry sanding may be used to grind down rough edges on sheet metal, or an electropolishing process may be used. Wet and dry sanding may be used to create a bevel on the sheet metal edges, reducing the sharpness of the corners and making them more rounded. Electropolishing may strip the surface layer of the sheet metal, leaving a microscopically-smooth surface that is stronger and easier to clean. Many custom metal forms made for the pharmaceutical and food industries may be electropolished. These deburring processes help to minimize the risk of injury to anyone handling the sheet metal later on. Sheet metal may also be polished, which may enhance the physical appearance of the metal, and can also increase the sanitary benefits of the material. The sheet metal may be polished using abrasives attached to a flexible backing to improve the overall surface finish of the metal. The shaving blade picking tool 10 may have all the edges 20 and 38, corners 28, and faces 19 and 35 polished. The polishing of the picking tool 10 may increase the appearance, safety, and sanitary benefits of the material. The picking tool 10 may have all edges 20 and 38, and corners 28 beveled or rounded. The beveling of the edges 20 of the pick part 12, the edges 38 of the finger grip part 30 and the corners 28 may reduce the sharpness of the picking tool 10, and may help prevent the user from cutting themselves during use.

Referring to FIGS. 1, 1A, 2, 2A, the shaving blade picking tool 10 may have suitable dimensions for its intended purpose. The picking tool 10 may have a suitable length 10A, between leading end 14 of pick part 12 and trailing end 34 of handle part 30, of a suitable range, such as 3-4 millimeters, for example between 3.6 and 3.9 millimeters in maximum length 10A. The length 10A may be a function of the lengths 24 and 42 of the pick part 12 and grip part 30. A lateral width of the picking tool 10 may be dependent on a lateral width 40 of the finger grip part 30, as such may be the widest part of the tool 10. The pick part 12 may have any suitable length, such as a length 24 between leading and trailing ends 14 and 16 of the pick part 12, of between 2 and 6 millimeters, for example 5 millimeters. A lateral width 22 of the pick part 12 between opposed sides 18 of the peripheral pick part side edge 27 may be between 2 and 10 millimeters, for example between 5 and 8 millimeters. A thickness 26 of the pick part 12 may be defined between the opposed faces 19 of the pick part 12, and may be between 0.01 and 0.05 millimeters, for example between 0.2 and 0.3 millimeters. A lateral width 22 of the pick part 12 between opposed sides 18 of the peripheral pick part side edge 20 may be between 2 and 10 millimeters. A thickness 44 of the finger grip part 30 may be defined between the opposed faces 35 of the finger grip part 30, and may be between 0.01 and 1 millimeters.

Referring to FIG. 3, the razor 48 may comprise a variety of parts. A head 50 of the razor 48 may define a leading end 52, a trailing end 54, sides 56, a front cutting face 58 and a rear face 60. The head 50 of the razor 48 may be connected to a handle 66. The blades 68 may be attached to the head 50 of the razor 48. A mounting end 70 of the blades 68 may mount to a flexible material mount 78, allowing the blades 68 of the razor 48 to have increased flexibility, compared to if the blades 68 were mounted to a rigid material. The flexible material 78 may be underneath the mounting flange 76. The blades 68 may be orientated to provide a specific direction of cutting 62 along an axis of cutting 64, representing the direction of motion of the head 50 over the skin surface during cutting. The front cutting face 58 head 50 may have a comfort face pad 80 on the leading end 52 and a lotion pad 82 of the trailing end 54. Referring to FIGS. 4-7, the blades 68 may have a suitable shape, such as an L-shape. Each blade 68 may have a blade end 72 and a blade arm 74. The blade arm 74 may support the blade end 72 and may define a base of the L-shape, while a blade end 72 may comprise the stem of the L-shape. The blade end 72 may be tapered as shown to provide a knife edge capable of cutting hair.

Referring to FIGS. 3-7, the tool 10 may be used to dislodge debris between adjacent blades 68 of a razor 48 in a suitable fashion. In use, the pick part 12 may be inserted into a blade gap 86 defined between adjacent blades 68 of a multi-blade hair razor 48. The pick part 12 may be used to remove clumps of hair and debris 96 from between the blades 68. Referring to FIGS. 3 and 8, inserting the pick part 12 of a shaving blade picking tool 10 between adjacent blades 68 of a multi-blade hair razor 48 may be used to dislodge debris or clumps of hair and debris 96 between the adjacent blades 68. The pick part 12 may be extended from the leading end 32 of a finger grip part 30, which may be operated by a user whose finger tips grip opposed finger-tip-contacting faces 35 of the finger grip part 30. The method may be carried out under running water to facilitate the clearing out of debris 96 as it is dislodged by tool 10.

Referring to FIGS. 3-4 and 6-7, in use the pick part 12 may be inserted between the adjacent blades 68 from the front cutting face 58 of the blade-mounting head 50 of the multi-blade hair razor 48. The pick part 12 may be inserted between the blades 68 into the blade gap 86, which may define a front blade gap thickness 87, for example in the direction shown by the arrow 98. The thickness 26 of the pick part 12 may be sized to be less than the gap thickness 87, so that the pick part 12 may insert within the blade gap 86. In some cases, the thickness 26 of the pick part 12 may be less than gap thickness 87 only when the adjacent blades 68 are at maximum separation, such as when one blade is depressed as shown in FIGS. 6 and 7 from pressure from the pick part 12. Once inserted into the blade gap 86, the pick part 12 may be used to remove clumps of hair and debris 96 from between the blades 68, for example by dislocating such debris 96 in the direction of arrow 98 out the rear face 60. The pick part 12 may move into the blade gap 86 along the blade gap entry axis 92. Referring to FIGS. 6 and 7, the pick part 12 may depress the blade 68 when entering the blade gap 86, as shown by an arrow 90. The blades 68 are able to be depressed by the pick part 12 without getting damaged due to the flexible material mount 78 which is used to mount the blades 68. The depression of the blade 68, as shown by the arrow 90, may allow the pick part to insert further into the blade gap 86, at a shallower angle of entry as shown, causing more clumps of hair and debris 96 to be dislodged.

Referring to FIGS. 4 and 5, in use the pick part 12 may be inserted between the adjacent blades 68 from a rear face 60 of blade-mounting head 50 of the multi-blade hair razor 48. The pick part 12 may be inserted between the blade gap 86, which may define a rear blade gap thickness 88, for example in the direction shown by the arrow 100. The thickness 26 of the pick part 12 may be sized to be less than the gap thickness 88, so that the pick part 12 may insert within the blade gap 86. In some cases, the thickness 26 of the pick part 12 may be less than gap thickness 88 only when the adjacent blades 68 are at maximum separation, such as when one blade is depressed to the right as shown in FIG. 5 from pressure from the pick part 12. Once inserted into the blade gap 86, the pick part 12 may be used to remove clumps of hair and debris 96 from between the blades 68. The pick part 12 may move into the blade gap 86 along the blade gap rear entry axis 94. The pick part 12 may depress or separate the blade 68 when entering the blade gap 86, as shown by the blade movement arrow 90. The blades 68 are able to be depressed by the pick part 12 without getting damaged due to the flexible material mount 78 which is used to mount the blades 68. The depression of the blade 68, as shown by the arrow 90, may allow the pick part to insert further into the blade gap 86, causing more clumps of hair and debris 96 to be dislodged. Referring to FIG. 8 the rear face 60 of the head 50 may define windows 102 to access the blades 68 from the rear. The windows 102 may be formed between columns 104 that may be present spanning the ends of the head 50 for the structural integrity of the head 50. The lateral width 22 of the pick part 12 may be sized to be less than a lateral width 106 of the window 102, which may allow the pick part 12 to insert into the blade gap 86.

The tool 10 may have suitable dimensions and characteristics. The pick's thickness may be selected at 0.01 inches (0.254 mm). Such gauge may provide a suitable mass for handling and use of the tool. The pick may be divided in simple fractions. From a 40 mm line on the y-axis a point is marked 25 mm down from the top or 15 mm from the bottom. At that point, a 30 mm line is drawn on the x-axis, 15 mm to either side of the vertical line. At four fifths of those two 15 mm lines on the x-axis (12 mm) a mark is indicated. Half way up the y-axis from that point is 12.5 mm (half of 25) and half way down is 7.5 mm (half of 15 mm). These may be the defined points of the perimeter where the arc of the design meets. Such may be similar to the shape of a shield or kite, except what is typically considered the top in those examples is the bottom in the shaving tool. These dimensions are intended to create a size comfortable to handle, and a shape and length that if too long, would have too much vibration at the end of the prong, and if too short, not enough range of mobility. From the apex of the 40 mm vertical line, an additional 2.5 mm extension may be added (3 mm in the drawing). The prong may be extended 8 mm horizontally with a ninety degree drop down to the arches. In some cases the arch is important because if the manual base was squared with the prong, the base may jam against the side of the razor compartment if the prong was not long enough (a long prong makes too much vibration). The arch may give the tool room to function while maintaining the stability of the structure. An 8 mm width of the prong is intended to offer suitable mobility through the blades in relation to the general size cartridge. Wider or narrower may give or take away freedom or restriction of mobility. The dimensions may be intended to give the user a usefule possible hand tool to manage cleaning between razor blades. The design shown may be similar to a guitar pick and has its roots in one, however each dimension is carefully adjusted from such. Sixty two and a half percent is the top and thirty seven and a half percent is the bottom. The width is seventy five percent of the height. The arc is eighty percent of the width and fifty percent of the two vertical parts. There is a combination of standard fractions including the quarter millimeter thickness that form the square and circular shape of the design important for the effectiveness of use. The shape enables handling surface area and length of use without over extension or interference with the razor cartridge or razor blades. The tool may be designed to dig laterally with the least amount of interference. If the prong was too long there would be a wider angle with less motion in relation to vertical movement and interference between top and bottom razor blades. And vibration as previously noted. The average space between adjacent blades is 2.25 mm.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1-19. (canceled)

20. A method comprising inserting a pick part of a shaving blade picking tool between adjacent blades of a multi-blade hair razor to dislodge debris between the adjacent blades, in which the pick part is extended from a leading end of a finger grip part, which is operated by a user whose finger tips grip opposed finger-tip-contacting faces of the finger grip part.

21. The method of claim 20 in which:
the finger grip part has opposed finger-tip-contacting faces separated by a peripheral side edge; and
the peripheral pick part side edge is sized to fit between adjacent blades of a multi-blade hair razor in use.

22. The method of claim 21 in which the pick part defines prongs at a leading end of the pick part.

23. The method of claim 22 in which the prongs are defined by opposed corners at the leading end of the pick part.

24. The method of claim 23 in which the pick part is rectangular in shape with:
a straight leading edge, which defines the leading end of the pick part and the opposed corners; and
straight side edges, which extend from the finger grip part to the leading end of the pick part.

25. The method of claim 21 in which the finger grip part has an oblong, bulbous planar shape with the peripheral side edge being curved.

26. The shaving blade picking tool of claim 1 in which the pick part is integrally connected to the finger grip part.

27. The method of claim 26 in which the finger grip part and pick part form a sheet.

28. The method of claim 27 in which the finger grip part and pick part are formed by sheet metal punching.

29. The method of claim 21 in which the shaving blade picking tool comprises metal.

30. The method of claim 29 in which the metal comprises stainless steel.

31. The method of claim 29 in which all edges, corners, and faces of the shaving blade picking tool are polished.

32. The method of claim 27 in which all edges and corners of the shaving blade picking tool are beveled or rounded.

33. The method of claim 21 in which a thickness of the pick part defined between the opposed faces of the pick part is between 0.01 and 0.5 millimeters.

34. The method of claim 33 in which the thickness of the pick part is between 0.2 and 0.3 millimeters.

35. The method of claim 21 in which a lateral width of the pick part between opposed sides of the peripheral pick part side edge is between 2 and 10 millimeters.

36. The method of claim 35 in which the lateral width is between 5 and 8 millimeters.

37. The method of claim 21 in which a length of the pick part between leading and trailing ends of the pick part is between 2 and 6 millimeters.

38. The method of claim 21 in which the pick part is inserted between the adjacent blades from one of:
a front cutting face of a blade-mounting head of the multi-blade hair razor; or
a rear face of a blade-mounting head of the multi-blade hair razor.
